(19) United States
(12) Patent Application Publication
(10) Pub. No.: US 2023/0175865 A1
(43) Pub. Date: Jun. 8, 2023

(54) USER EQUIPMENT SENSOR CALIBRATION

(71) Applicant: QUALCOMM INCORPORATED, San Diego, CA (US)

(72) Inventors: Marwen ZORGUI, San Diego, CA (US); Lorenzo FERRARI, Castro Valley, CA (US); Alexandros MANOLAKOS, Escondido, CA (US); Balwinderpal S. SACHDEV, San Diego, CA (US)

(21) Appl. No.: 17/997,290

(22) PCT Filed: Jun. 23, 2021
(86) PCT No.: PCT/US2021/038616

§ 371 Date: Oct. 27, 2022

(30) Foreign Application Priority Data
Jun. 30, 2020 (GR) 20200100379

(51) Int. Cl. G01C 25/00

(52) U.S. Cl. CPC G01C 25/005

(57) ABSTRACT

A method for determining sensor calibration parameters includes: obtaining a plurality of sets of sensor measurement values, in a sensor coordinate system, of a sensor of a user equipment; and determining the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An apparatus for determining sensor calibration parameters, the apparatus including comprising: a memory; at least one of a first sensor or a transceiver, and a processor communicatively coupled to the memory and to the at least one of the first sensor or the transceiver, where the processor is configured to: obtain, via the at least one of the first sensor or the transceiver, a plurality of sets of sensor measurement values, in a sensor coordinate system, of a second sensor of a user equipment; and determine the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

Another example apparatus for determining sensor calibration parameters includes: means for obtaining a plurality of sets of sensor measurement values, in a sensor coordinate system, of a sensor of a user equipment; and means for determining the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

An example method for determining sensor calibration parameters includes: obtaining a plurality of sets of sensor measurement values, in a sensor coordinate system, of a sensor of a user equipment; and determining the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

An example non-transitory, processor-readable storage medium includes instructions configured to cause a processor, in order to determine sensor calibration parameters, to: obtain a plurality of sets of sensor measurement values, in a sensor coordinate system, of a sensor of a user equipment; and determine the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a simplified block diagram of an example user equipment.

FIG. 6 is a simplified perspective view of an environment for calibrating sensor measurements of a UE.

FIG. 7 is a signal and process flow for UE-assisted determination of sensor calibration parameters and use of the sensor calibration parameters to determine UE position.

FIG. 8A is a perspective view of a sensor coordinate system and a reference coordinate system.

FIG. 8B is a perspective view of the sensor coordinate system and the reference coordinate system, with one axis of the sensor coordinate system rotated into alignment with an axis of the reference coordinate system.

FIG. 8C is a perspective view of the sensor coordinate system and the reference coordinate system, with all axes of the sensor coordinate system rotated into alignment with respective axes of the reference coordinate system.

FIG. 9 is a signal and process flow for UE-based determination of sensor calibration parameters and use of the sensor calibration parameters to determine UE position.

FIG. 10 is a block flow diagram of a method for determining sensor calibration parameters.

### DETAILED DESCRIPTION

Techniques are discussed herein for determining and using sensor calibration parameters. For example, three-dimensional accelerometer measurements may be made with a sensor (e.g., of a UE) at rest. These measurements may be used to derive a first rotation matrix to align one axis of a sensor coordinate system with an axis of gravity of a reference coordinate system. A second rotation matrix is determined using the first rotation matrix and is applied to (e.g., multiplied by) acceleration measurements minus expected acceleration measurements corresponding to the actual acceleration measurements. The first and second rotation matrixes may be applied to acceleration measurements to determine calibrated acceleration measurements in the reference coordinate system. The calibrated acceleration measurements may be used to determine a position estimate of the UE, e.g., using dead reckoning. Other techniques, however, may be used.

Items and/or techniques described herein may provide one or more of the following capabilities, as well as other capabilities not mentioned. Accuracy of position estimation of a UE may be improved. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed, and may be alternatively referred to as an Access Point (AP), a Network Node, a NodeB, an evolved NodeB (eNB), a general Node B (gNodeB, gNB), etc. In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

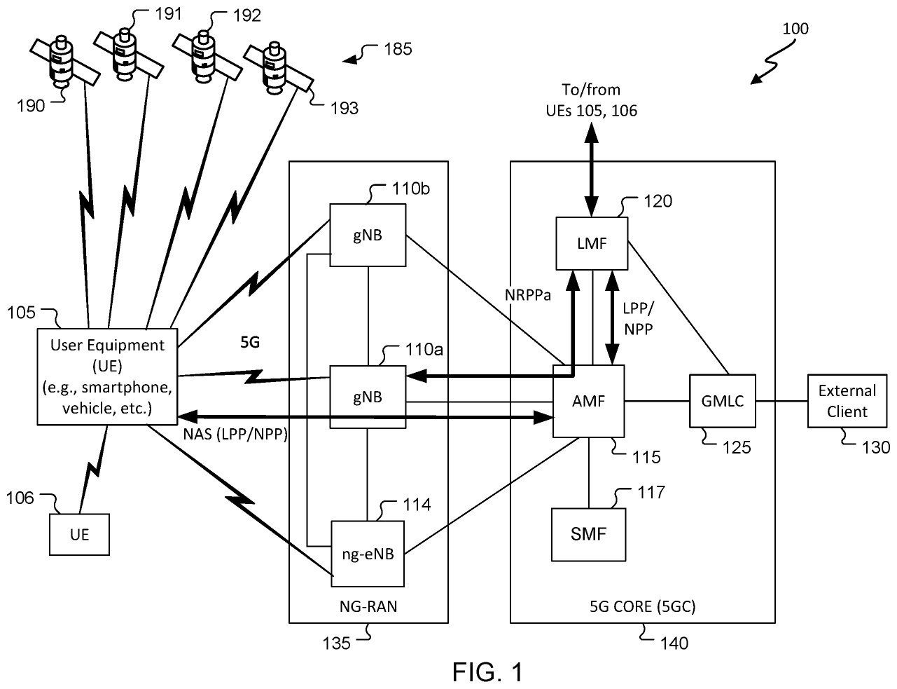

Referring to FIG. 1, an example of a communication system 100 includes a UE 105, a UE 106, a Radio Access Network (RAN) 135, here a Fifth Generation (5G) Next Generation (NG) RAN (NG-RAN), and a 5G Core Network (5GC) 140. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. The BSs 110a, 110b, 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more of the BSs 110a, 110b, 114 may be configured to communicate with the UE 105 via multiple carriers. Each of the BSs 110a, 110b, 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although only one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the BSs 110a, 110b, 114 and/or the network 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples only as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the BSs 110a, 110b, 114, the core network 140, and/or the external client 130. For example, such other devices may include internet of thing (IoT) devices, medical devices, home entertainment and/or automation devices, etc. The core network 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The BSs 110a, 110b, 114 may each comprise one or more TRPs. For example, each sector within a cell of a BS may comprise a TRP, although multiple TRPs may share one or more components (e.g., share a processor but have separate antennas). The system 100 may include only macro TRPs or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the BSs 110a, 110b, 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematics (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the core network 140, and may provide QoS (Quality of Service) flow and session management. The AMF 115 may support mobility of the UE 105 including cell change and handover and may participate in supporting signaling connection to the UE 105.

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown connected to both the AMF 115 and LMF 120, though only one of these connections may be supported by the 5GC 140 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 150. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE's position.

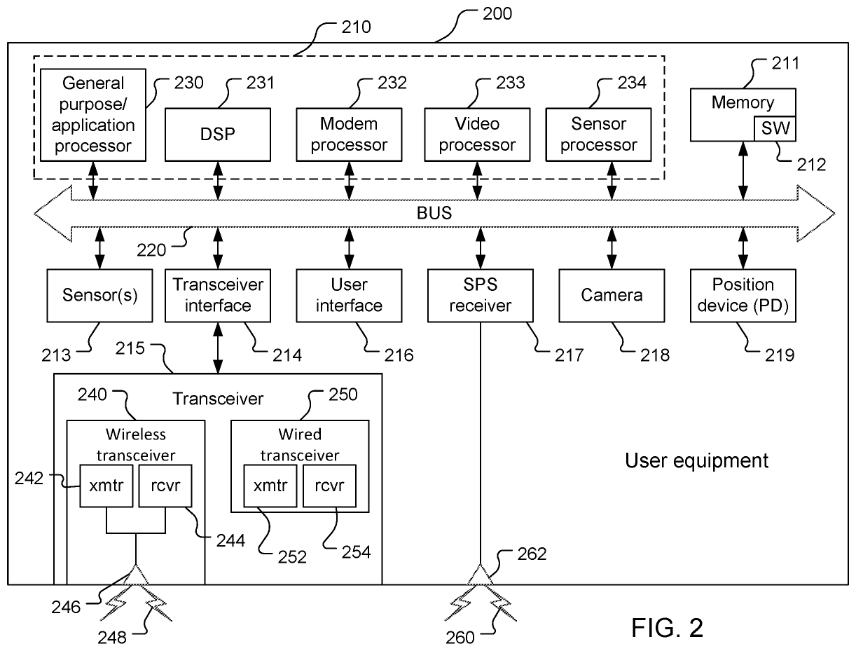

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identity, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer only to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, the wireless transceiver 240, and one or more of the sensor(s) 213, the user interface 216, the SPS receiver 217, the camera 218, the PD 219, and/or the wired transceiver 250.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to one or more antennas 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with the network 135 to send communications to, and receive communications from, the network 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless SPS signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer only to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general purpose/application processor 230, the transceiver 215, the SPS receiver 217, and/or another component of the UE 200, and may be provided by hardware, software, firmware, or various combinations thereof.

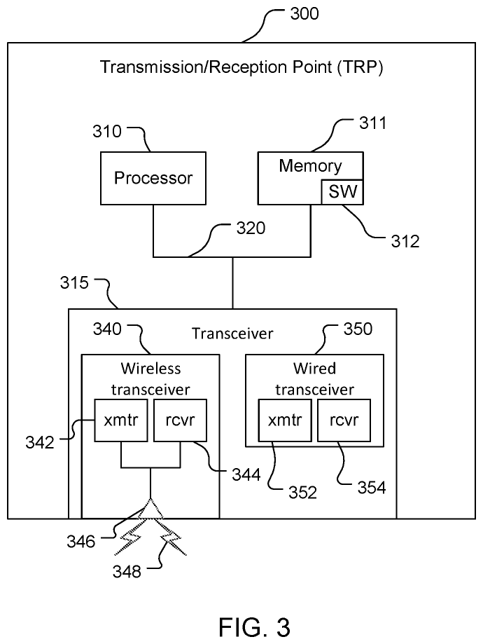

Referring also to FIG. 3, an example of a TRP 300 of the BSs 110a, 110b, 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless interface) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer only to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the BSs 110a, 110b, 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the network 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

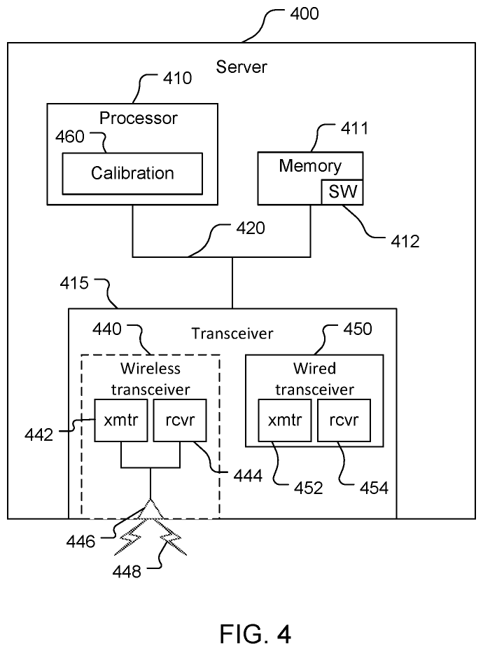

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the network 135 to send communications to, and receive communications from, the TRP 300, for example, and/or one or more other entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that only the UEs subscribed to the service can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., scrambling a PN code with another signal) such that a source of the PRS may serve as a pseudo-satellite (a pseudolite). The PN code may be unique to the PRS source (at least within a specified area such that identical PRS from different PRS sources do not overlap). PRS may comprise PRS resources or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource), can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple Resource Elements (REs) that may be in multiple Resource Blocks (RBs) within N (one or more) consecutive symbol(s) within a slot. An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning signals being sent by UEs, and with PRS and SRS for positioning signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

Sensor Calibration

To facilitate and improve the accuracy of position of a UE determined using sensor measurements, e.g., position determined using dead reckoning, one or more sensors of the UE may be calibrated. Calibration of the sensor(s) may be performed intermittently, e.g., at scheduled, periodic times with uniform intervals between calibrations, or aperiodically, e.g., in response to an ad hoc request, e.g., by the UE. Calibration parameters for a UE may be determined by the UE and/or by one or more other entities such as the TRP 300, the server 400, and/or another UE. For example, the UE may send an on-demand request for calibration parameters to another entity such as the TRP 300 and/or the server 400 and/or another entity such as another UE. As another example, the UE may periodically receive, and/or aperiodically send an on-demand request for calibration capability information from which the UE may calculate sensor calibration parameters. For periodic acquisition of calibration parameters or calibration capability information, the UE may send an indication of how often the UE would like the calibration parameters and/or the calibration capability information to be sent to the UE. Calibrating a sensor may help compensate for sensor drift (change in a bias and/or a scaling matrix), and thus help retain or improve sensor accuracy and thus accuracy of information derived from sensor information, such as UE position, UE heading, UE speed, etc.

Sensor calibration parameters may take a variety of forms. For example, the sensor calibration parameters may comprise an affine transformation characterized by a bias vector b and a scaling/rotation matrix R. For an example of acceleration calibration parameters, a calibrated acceleration, a_{calibrated}, may be determined according to:

a_{calibrated}=R_{eq}aₒᵤₜ+b (1)

where aₒᵤₜ is an acceleration measurement value, e.g., an uncalibrated output of an accelerometer, which may be a multi-dimensional value, e.g., a three-dimensional value, and R_{eq} is a rotation matrix for rotating a sensor coordinate system into alignment with a reference coordinate system. The bias vector b represents an effect of gravity that the accelerometer measures, which is potentially a constant bias to be canceled. As a constant bias of the device, the bias vector b may be provided by the manufacturer of the accelerometer.

Referring again to FIG. 4, the processor 410 (possibly in conjunction with the memory 411 and, as appropriate, (one or more portions of) the transceiver 415) includes a calibration unit 460. The calibration unit 460 may be configured to determine and/or provide calibration parameters and/or may be configured to provide calibration capability information to a UE and/or to another entity. Functionality of the calibration unit 460 is discussed further below, and the description may refer to the processor 410 generally, or the server 400 generally, as performing any of the functions of the calibration unit 460.

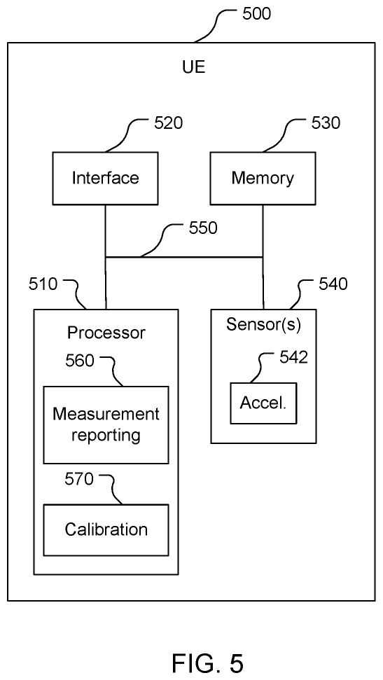

Referring to FIG. 5, with further reference to FIGS. 1-4, a UE 500 includes a processor 510, an interface 520, a memory 530, and one or more sensors 540 communicatively coupled to each other by a bus 550. The UE 500 may include the components shown in FIG. 5, and may include one or more other components such as any of those shown in FIG. 2 such that the UE 200 may be an example of the UE 500. The interface 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the interface 520 may include the wired transmitter 252 and/or the wired receiver 254. The memory 530 may be configured similarly to the memory 211, e.g., including software with processor-readable instructions configured to cause the processor 510 to perform functions. The sensor(s) 540 may include one or more of the sensor(s) 213, e.g., an accelerometer 542 that may be a three-dimensional accelerometer that includes three accelerometers each disposed and configured to measure acceleration along a respective axis of three axes, with the three axes being orthogonal to each other. The description herein may refer only to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function.

The processor 510 (possibly in conjunction with the memory 530 and, as appropriate, the interface 520) includes a measurement reporting unit 560 and a calibration unit 570. The measurement reporting unit 560 may be configured to report measurements from the sensor(s) 540 such as acceleration measurements from the accelerometer 542. The measurement reporting unit 560 may report the measurement(s) via the interface 520 to a network entity such as the TRP 300 and/or the server 400 and/or to another entity such as another UE. The reported measurement(s) may be used by the other entity(ies) to determine calibration parameters for the sensor(s) 540, thus providing for UE-assisted sensor calibration. The calibration unit 570 may be configured to calculate calibration parameters for the sensor(s) 540 such as for the accelerometer 542. The calibration unit 570 may be configured to use information received via the interface 520 to calculate the calibration parameters. Determination of the sensor calibration parameters by the calibration unit 570 provides UE-based sensor calibration (and may be considered TRP-assisted or server-assisted sensor calibration if the calibration unit 570 uses information, e.g., calibration capability information, provided by the TRP 300 or the server 400 to determine the calibration parameters). Functionality of the measurement reporting unit 560 and functionality of the calibration unit 570 are discussed further below, and the description may refer to the processor 510 generally, or the UE 500 generally, as performing any of the functions of the measurement reporting unit 560 and/or the calibration unit 570.

UE-Assisted Sensor Calibration

The UE 500 may assist another entity to determine sensor calibration parameter for the sensor(s) 540 of the UE 500. The UE 500 may obtain the calibration parameters and use the calibration parameters to adjust one or more sensor measurements and use the adjusted measurement(s) to determine a location of the UE 500, e.g., by dead reckoning.

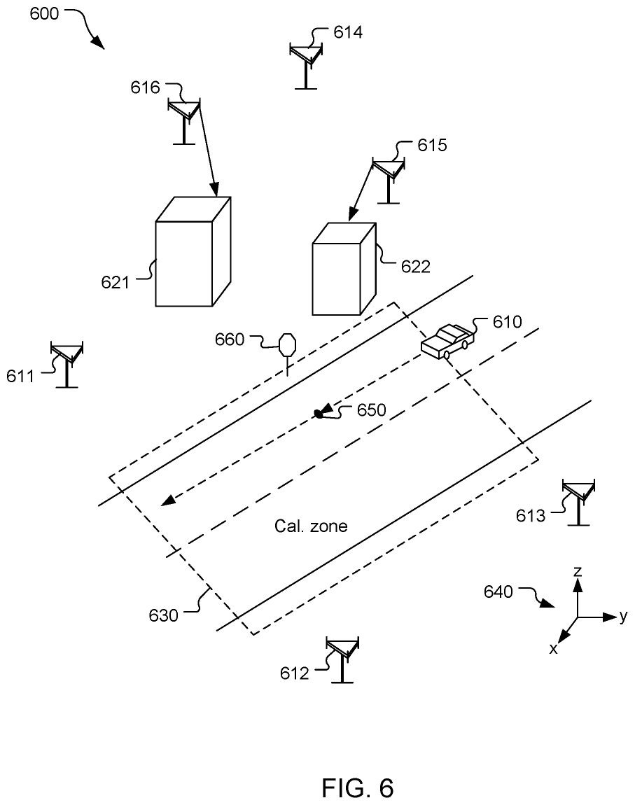

Referring also to FIG. 6, an environment 600 includes a UE 610 (e.g., an example of the UE 500), base stations 611, 612, 613, 614, 615, 616 (e.g., gNBs), and objects 621, 622. In this example, the environment 600 is an outdoor environment, the UE 610 is a vehicle, and the objects 621, 622 are buildings. The environment 600 includes a calibration zone 630 that may have line of sight with different combinations of base stations over the calibration zone 630, and may have every portion of the calibration zone 630 have line of sight (LOS) with at least three base stations. In this example, every part of the calibration zone 630 has LOS with at least the base stations 611-613, and parts of the calibration zone 630 have LOS with one or more other base stations, e.g., the base station 614 and/or the base station 615.

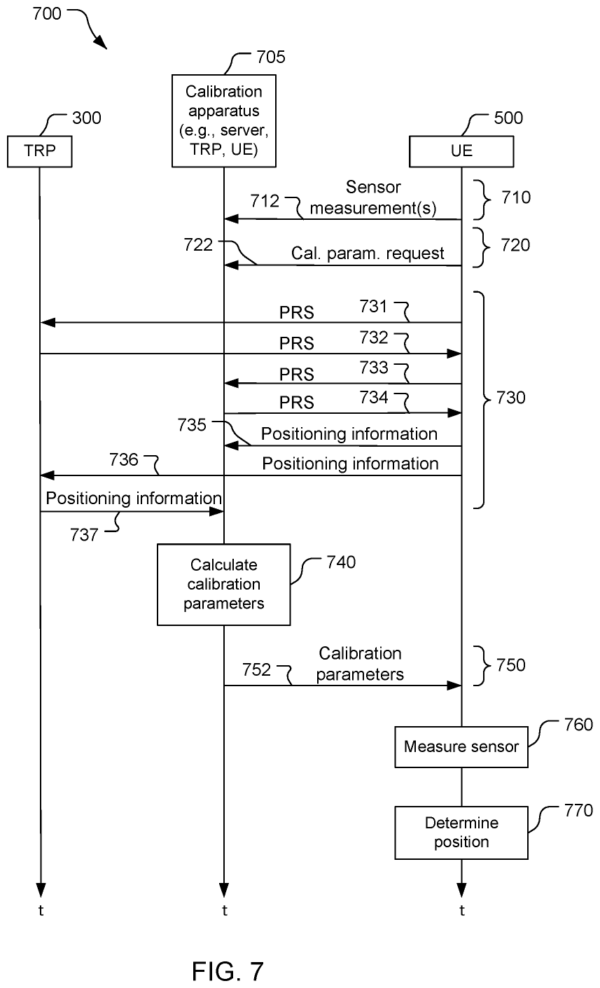

Referring also to FIG. 7, a signaling and process flow 700 for UE-assisted determination of sensor calibration parameters and use of the sensor calibration parameters to determine UE position includes the stages shown. The flow 700 is an example only, as stages may be added, rearranged, and/or removed. For example, a stage 720 and/or one or more portions of a stage 730 may be omitted. As another example, stage 710 may be performed after stage 720. Still other examples are possible.

At stage 710, the UE 500 may send one or more sensor measurements to an apparatus 705 in one or more sensor measurement messages 712. For example, the measurement reporting unit 560 may be configured to report sensor measurements via the interface 520 to another entity. For example, the measurement reporting unit 560 may report acceleration measurements of three orthogonal axes of a sensor, e.g., the accelerometer 542, and/or displacements along the three orthogonal axes between time instants. The sensor measurements obtained and reported by the measurement reporting unit 560 may be measured by the sensor(s) 540 while the UE 500 is stationary or while the UE 500 is moving. For a three-dimensional acceleration measurement, including three measurements corresponding to three orthogonal axes of a sensor coordinate system, one or two of the measurements may be zero, or all three of the measurements may be non-zero. The sensor coordinate system will likely not be aligned, at least not along three orthogonal axes, with a reference coordinate system, e.g., a reference coordinate system 640 (e.g., a coordinate system of the Earth with an origin at sea level). The measurement reporting unit 560 may be configured to report sensor measurements, using an information element (IE) called Sensor-MotionInformation, to the apparatus 705 (e.g., the TRP 300, the server 400, another UE, and/or another entity). In the discussion herein, the apparatus 705 is assumed to be the server 400, but this is an example, and the discussion and claims apply to other entities as the apparatus 705.

At stage 720, the UE 500 sends a calibration parameter request 722 to the apparatus 705. For example, the processor 510 may be configured to send a request to the apparatus 705 to trigger, aperiodically, determination and provision of sensor calibration parameters to the UE 500. Alternatively, one or more of the sensor measurement message(s) 712 may act as a calibration parameter request, e.g., including an explicit request for calibration parameters or be an implicit (e.g., agreed upon) request for calibration parameters. The UE 500 may be configured to send the calibration parameter request 722 periodically, or may send the request 722 periodically or aperiodically and may explicitly and/or implicitly indicate one or more periodicity parameters for the apparatus 705 to provide calibration parameters per the periodicity parameters (e.g., a frequency of providing the calibration parameters). The periodicity parameter(s) may be an implicit indication for controlling the provision of the calibration parameters by the apparatus 705. For example, the implicit indication may be a sensor drift rate that implicitly indicates a frequency for the apparatus 705 to provide calibration parameters, e.g., to avoid the sensor exceeding a threshold drift.

At stage 730, positioning signals and/or positioning information are provided to the apparatus 705. For example, PRS 731 and/or PRS 732 may be exchanged between the UE 500 and the TRP 300 and/or PRS 733 and/or PRS 734 may be exchanged between the UE 500 and the apparatus 705. For example, the UE 610 may exchange PRS with one or more of the base stations 611-613 and/or another UE and/or another entity (e.g., the server 400). The UE 500 may be configured to provide positioning information (e.g., one or more PRS measurements) to the apparatus 705 in a positioning information message 735 and/or to provide positioning information a positioning information message 736 to the TRP 300. The TRP 300 may be configured to provide positioning information for the UE 500 in a positioning information message 737 to the apparatus 705.

At stage 740, the apparatus 705 calculates sensor calibration parameters 740 for the UE 500. For example, the calibration unit 460 of the server 400 may calculate the calibration parameters in accordance with Equation (1). The calibration unit 460 may be configured to determine the value of the rotation matrix R_{eq} based on the sensor measurement(s) received from the UE 500 and the position of the UE 500 over time.

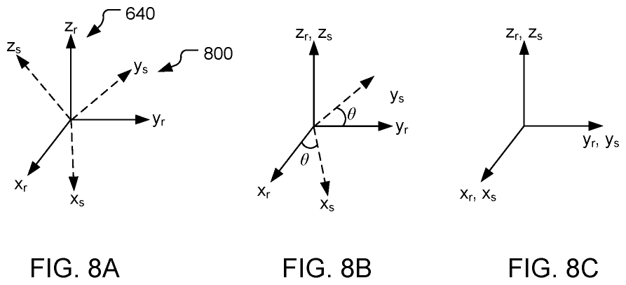

Referring also to FIGS. 8A, 8B, 8C, the calibration unit 460 may be configured to determine the rotation matrix R_{eq} as a combination of two rotation matrixes. The calibration unit 460 may be configured to determine a first rotation matrix to align a first sensor axis zₛ of a sensor coordinate system 800 (i.e., a coordinate system relative to the sensor, e.g., the accelerometer 542, with an origin at the sensor), shown in dashed lines, with a reference vertical axis zᵣ, e.g., a vertical axis of the reference coordinate system 640, shown in solid lines. As shown in FIG. 8A, initially the sensor coordinate system 800 may be completely misaligned with the reference coordinate system 640. Application of the first rotation matrix to measurements in the sensor coordinate system will effectively rotate the first sensor axis zₛ to be aligned with the reference vertical axis zᵣ as shown in FIG. 8B. Application of the first rotation matrix may alter a relationship of a second sensor axis xₛ of the sensor coordinate system 800 relative to a first reference horizontal axis xᵣ of the reference coordinate system 640 and/or may alter a relationship of a third sensor axis yₛ of the sensor coordinate system 800 relative to a second reference horizontal axis yᵣ of the reference coordinate system 640. The positions of the second sensor axis xₛ relative to the first reference horizontal axis xᵣ and the third sensor axis yₛ relative to the second reference horizontal axis yᵣ shown in FIG. 8B are closer than those shown in FIG. 8A, but this is an example, and application of the first rotation matrix may not improve one or more of these relationships. A second rotation matrix, applied in combination with the first rotation matrix (e.g., applied to results of application of the first rotation matrix) will rotate the sensor coordinate system 800 such that the second sensor axis xₛ of the sensor coordinate system 800 will align with the first reference horizontal axis xᵣ of the reference coordinate system 640 and the third sensor axis yₛ of the sensor coordinate system 800 will align with the second reference horizontal axis yᵣ of the reference coordinate system 640 as shown in FIG. 8C. The rotation to align the second and third sensor axes with the first and second reference horizontal axes is a two-dimensional angular rotation, e.g., of an angle θ. “Align” as used herein may not be perfect alignment, e.g., may correspond to an approximate alignment, e.g., a best alignment between each of a set of possible orientations of the sensor coordinate system 800 relative to the reference coordinate system 640.

The calibration unit 460 may be configured to calculate the first rotation matrix based on sensor measurements with the sensor 540 at rest (i.e., not moving). A rotation matrix R may be represented by a quaternion q containing four values a, b, c, and d, where a norm of the quaternion equals one (i.e., ∥q∥=1). In terms of the quaternion values, the rotation matrix R is given by:

$$R = ( \begin{matrix}{a}^{2} + {b}^{2} + {c}^{2} + {d}^{2} & 2 bc - 2 ad & 2 bd + 2 ac \\ 2 bc + 2 ad & {a}^{2} - {b}^{2} + {c}^{2} - {d}^{2} & 2 cd - 2 ab \\ 2 bd - 2 ac & 2 cd + 2 ab & {a}^{2} + {b}^{2} + {c}^{2} + {d}^{2}\end{matrix} ) \qquad ( 2 )$$

The calibration unit 460 may determine the rotation matrix R by determining the quaternion that satisfies the following non-linear, least-squares equation:

$${min}_{q} f ( q ) = {\sum }_{i = 1}^{N s} {‖ R ( q ) {a}_{o u t , i} - [ 0 ; 0 ; g ] ‖}^{2} \qquad ( 3 )$$

where ∥q∥=1, Ns is a number of the sensor measurements measured by the sensor 540 at time instances i while the sensor 540 was at rest (i.e., while the UE 500 was at rest), a_{out,i} is the output (measurement) of the accelerometer 542 at the time instances i, and g is gravitational acceleration (e.g., 9.8 m/s²) at the sensor 540. For example, one or more of the measurements a_{out,i} may be acquired while the UE 610 is stopped at a spot 650 in adherence of a stop sign 660. The calibration unit 460 may be configured to determine the first rotation matrix by determining which of a set of first candidate rotation matrixes (e.g., candidate quaternions) yields a smallest sum of a norm of a product of one of the first candidate rotation matrixes and one of the accelerometer measurement values (which may include multiple values corresponding to the multiple sensor axes), minus a gravity vector in the reference coordinate system, for each of the accelerometer measurement values with the UE 500 at rest (at least each of such measurements chosen to be used, although more such measurements may be available). The first candidate rotation matrixes may be determined in a variety of ways, with the first candidate rotation matrixes satisfying the condition ∥q∥=1. The quaternion that satisfies Equation 3 may be labeled q* and the corresponding rotation matrix labeled R(q*).

The calibration unit 460 may be configured to calculate the second rotation matrix based on application of the first rotation matrix to sensor measurement values, here acceleration values, and expected sensor measurement values, here expected acceleration measurements based on motion of the UE 500. The sensor measurement values used to determine the second rotation matrix may be new, i.e., different than the sensor measurements used to determine the first rotation matrix. For example, the sensor measurement values used to determine the second rotation matrix may be obtained by the accelerometer 542 while the UE 500 is in motion. The calibration unit 460 may determine the second rotation matrix R(θ) by determining the angle θ that satisfies the following non-linear, least-squares equation:

$${min}_{θ} f ( θ ) = {\sum }_{i = 1}^{N} {‖ R ( θ ) {\tilde{a}}_{o u t , i} - {a}_{gd {,}_{i}} ‖}^{2} \qquad ( 4 )$$

where

$$R ( θ ) = ( \begin{matrix}cos θ & sin θ & 0 \\ - s in θ & cos θ & 0 \\ 0 & 0 & 1\end{matrix} ) \qquad ( 5 )$$

and where

f′(θ)=cos θΣᵢ(ã_{out,i}(1)a_{gd,}_{ᵢ}(2)−ã_{gd,}_{ᵢ}(1))+sin θΣᵢ(ã_{out,i}(2)+ã_{gd,}_{ᵢ}(2)+ã_{out,i}(1)a_{gd,}_{ᵢ}(1)) (6)

and

f′(θ)=0 →θ*→R(θ*) (7)

where a(i) is the i-th component of a vector a. The second rotation matrix R(θ) corresponds to a two-dimensional rotation in the horizontal, x-y, plane of the reference coordinate system 640. The vector ã_{out, i} is the sensor output, e.g., the measurement output by the accelerometer 542, at time i after applying the first rotation matrix. The vector a_{gd,}_{ᵢ} is an estimated measurement based on position of the sensor 540 (e.g., position of the UE 500) over time, e.g., as determined using one or more positioning techniques and/or information obtained through one or more of the messages 735-737 and/or one or more of the PRS 731, 733 during stage 730, and/or determined from a-priori knowledge, and/or determined from other information (e.g., a neighbor base station list, etc.). Using the position of the UE 500 over time, the calibration unit 460 may estimate the expected acceleration (e.g., in the three reference coordinate system axes). For example, position of the UE 610 may be determined at multiple instances at multiple locations in the calibration zone 630. The calibration zone 630 may be chosen such that the orientation of the first sensor axis zₛ relative to the vertical reference axis zᵣ is substantially constant and has substantially the same relationship during the sensor measurements as with the UE 610 at rest. For example, the calibration zone 630 may be chosen as a substantially planar region substantially such that the angle between the vertical reference axis zᵣ and the first sensor axis zₛ will vary by no more than a threshold variance (e.g., 10°) with the UE 610 anywhere in the calibration zone 630. The calibration unit 460 may use Equations (4)-(7) to determine the second rotation matrix (and thus θ) by determining which of second candidate rotation matrixes yields a smallest sum of a norm of a product of one of the second candidate rotation matrixes and one intermediate sensor value (i.e., a sensor measurement with the first rotation matrix applied), minus a corresponding expected intermediate sensor value, for each of multiple intermediate sensor values. The calibration unit 460 may, for example, iterate values of θ to determine the second candidate rotation matrixes and evaluate Equations (4)-(7) to determine a value of θ that satisfies Equation (4) from the set of intermediate sensor values and drives the derivative in Equation (7) to zero.

The calibration unit 460 may be configured to determine the rotation matrix R_{eq} for Equation (1) as a composite rotation matrix using the first and second rotation matrixes R(q*) and R(θ). The calibration unit 460 may determine the composite rotation matrix R_{eq} as a combination of the first and second rotation matrixes R(q*) and R(θ) according to:

R_{eq}=R(θ*)R(q*) (8)

At stage 750, the apparatus 705 provides the calibration parameters to the UE 500 in a calibration parameter message 752. The apparatus 705 may provide the composite rotation matrix R_{eq} in the calibration parameter message 752, or may provide the first and second rotation matrixes individually, or may provide other information from which to determine the composite rotation matrix, e.g., θ* and q*.

At stage 760, the UE 500 obtains one or more sensor measurements. For example, the accelerator 542 takes several measurements over time, e.g., for use in dead-reckoning positioning.

At stage 770, the UE determines a position estimate of the UE 500. For example, the processor 510 may apply the composite rotation matrix from Equation (8) to each of the sensor measurements from the accelerometer 542 to calculate adjusted acceleration measurements (in the reference coordinate system 640). The processor 510 may use the adjusted acceleration measurements to determine relative motion of the UE 500 in the reference coordinate system 640, and determine a present position estimate of the UE 500 based on the cumulative relative motions since a previously-known (e.g., calculated, received, etc.) position estimate of the UE 500.

UE-Based Sensor Calibration

The UE 500 may determine sensor calibration parameters for the sensor(s) 540 of the UE 500. The UE 500 may obtain calibration capability information from one or more other entities in order to determine the calibration parameters. The UE 500 may use the calibration parameters to adjust one or more sensor measurements and use the adjusted measurement(s) to determine a location of the UE 500, e.g., by dead reckoning.

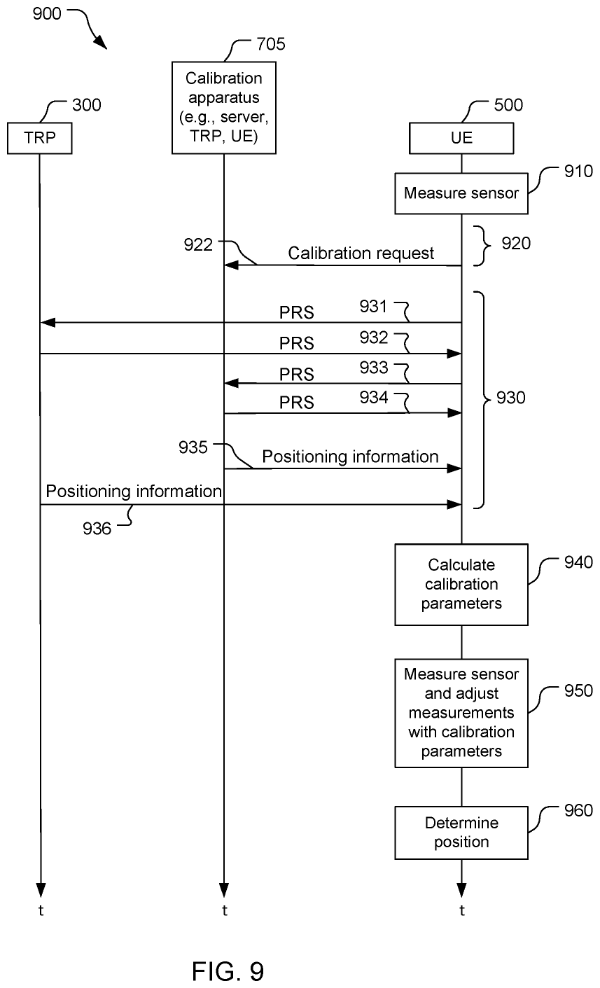

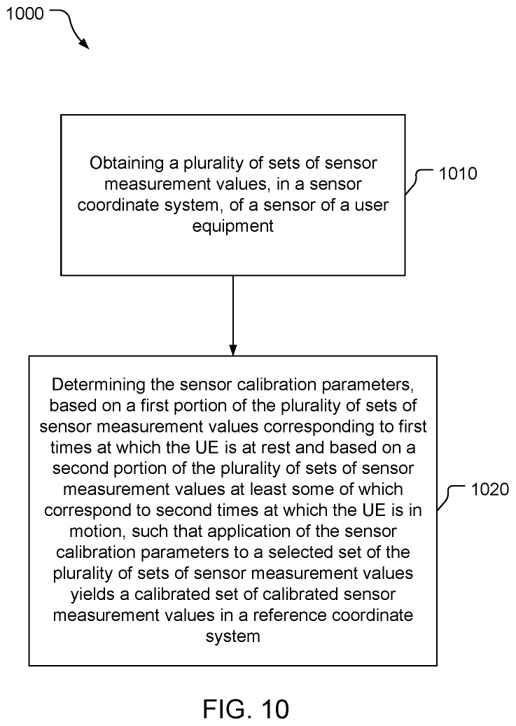

Referring also to FIG. 9, a signaling and process flow 900 for UE-based determination of sensor calibration parameters and use of the sensor calibration parameters to determine UE position includes the stages shown. The flow 900 is an example only, as stages may be added, rearranged, and/or removed. For example, a stage 920 and/or one or more portions of a stage 930 may be omitted.

At stage 910, the UE 500 obtains sensor measurements. For example, the accelerometer 542 takes multiple measurements with the UE 500 at rest. The measurement reporting unit 560 may report the measurements to the memory 530 or may not report the measurements. The measurement reporting unit 560 may be omitted from the UE 500.

At stage 920, the UE 500 may send a calibration request message 922 to the apparatus 705. The calibration request message 922 may request the apparatus 705 to provide positions of the UE 500 over time and/or to provide positioning information and/or positioning signals to the UE 500 from which the UE 500 may determine position of the UE 500 over time.

At stage 930, positioning signals and/or positioning information are provided to the UE 500. For example, PRS 931 and/or PRS 932 may be exchanged between the UE 500 and the TRP 300 and/or PRS 933 and/or PRS 934 may be exchanged between the apparatus 705 and the UE 500. The apparatus 705 may provide positioning information (e.g., UE position estimate(s), PRS measurement(s), etc.) to the UE 500 in a positioning information message 935 and/or the TRP 300 may provide positioning information (e.g., UE position estimate(s), PRS measurement(s), etc.) to the UE 500 in a positioning information message 936. The UE 500 may use any information regarding any of the PRS 931-934 (e.g., measurement(s)) and/or positioning information from either or both of the messages 935, 936 to determine position estimates of the UE 500 corresponding to different times.

At stage 940, the UE 500 may calculate the calibration parameters. For example, the calibration unit 570 may calculate the composite rotation matrix R_{eq} as discussed above using accelerometer measurements with the UE 500 at rest, accelerometer measurements, e.g., with the UE 500 moving, and position estimates of the UE 500 with the UE 500 moving to determine expected acceleration measurements.

At stages 950 and 960, similar to stages 760 and 770, the UE 500 may take sensor measurements, adjust the measurements with the calibration parameters, and determine one or more position estimates of the UE 500, e.g., using dead reckoning.

Operation

A method 1000 for determining sensor calibration parameters includes the stages shown. The method 1000 is, however, an example only and not limiting. The method 1000 may be altered, e.g., by having stages added, removed, rearranged, combined, performed concurrently, and/or having single stages split into multiple stages. The method 1000 may be for UE-assisted determination of the calibration parameters or UE-based determination of the calibration parameters, or a combination thereof.

At stage 1010, the method 1000 includes obtaining a plurality of sets of sensor measurement values, in a sensor coordinate system, of a sensor of a user equipment. For example, the UE 500 takes sensor measurements at stage 710 or at stage 910. The sensor measurements may include, for example, measurements while the UE 500 is at rest and measurements while the UE 500 is moving. Each set of sensor measurement values may comprise values of a three-dimensional measurement, i.e., a measurement value for each of three orthogonal directions. The processor 510, possibly in conjunction with the memory 530, and the sensor(s) 540 may comprise means for obtaining a plurality of sets of sensor measurement values. Also or alternatively, a processor of another entity may receive sensor measurements, directly or indirectly, from the UE 500. For example, the processor 410, possibly in conjunction with the memory 411, and the transceiver, e.g., the wireless receiver 444 and the antenna 446, may comprise means for obtaining a plurality of sets of sensor measurement values. Also or alternatively, the processor 310, possibly in conjunction with the memory 311, and the transceiver 315, e.g., the wireless receiver 344 and the antenna 346, may comprise means for obtaining a plurality of sets of sensor measurement values.

At stage 1020, the method 1000 includes determining the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system. For example, the apparatus 705 may calculate the calibration parameters using Equation (1) (and Equations (2)-(7)) at stage 740 or the UE 500 may calculate the calibration parameters at stage 940, or a combination thereof (e.g., the UE 500 may calculate the rotation matrix R(q*) and the apparatus 705 may calculate the rotation matrix R(θ), possibly reducing communication traffic as the apparatus 705 may determine position estimates for the UE 500 with less communication traffic than with the UE 500 determining the position estimates for the UE 500. The processor 510, possibly in conjunction with the memory 530, may comprise means for determining the sensor calibration parameters. The processor 410, possibly in conjunction with the memory 411, may comprise means for determining the sensor calibration parameters. The processor 310, possibly in conjunction with the memory 311, may comprise means for determining the sensor calibration parameters.

Implementations of the method 1000 may include one or more of the following features. In an example implementation, the reference coordinate system includes a first reference axis, a second reference axis, and a third reference axis, and the sensor coordinate system includes a first sensor axis, a second sensor axis, and a third sensor axis, and determining the sensor calibration parameters includes determining a first rotation matrix, based on the first portion of the plurality of sets of sensor measurement values and a reference value of the first reference axis, to rotate the sensor coordinate system to align the first sensor axis with the first reference axis. For example, the first rotation matrix may be determined such that application of the first rotation matrix to the first portion of the plurality of sets of sensor measurement values yields an intermediate set of intermediately-calibrated measurement values that include a first intermediately-calibrated sensor measurement value of the first reference axis. In another example implementation, the plurality of sets of sensor measurement values may be a plurality of sets of accelerometer measurement values. In another example implementation, the reference value may be a reference acceleration value, and the first reference axis may be aligned with a direction of gravity and the reference acceleration value may be a gravitational acceleration. The first rotation matrix may rotate an arbitrarily-disposed sensor coordinate system relative to the reference coordinate system, e.g., as shown in FIG. 8A, to align one axis of the sensor coordinate system with an axis of gravity of the reference coordinate system, e.g., as shown in FIG. 8B. The first portion of the accelerometer measurement values may be measured with the UE 500 at rest, e.g., with the only acceleration on the UE 500 being due to gravity. In another example implementation, determining the first rotation matrix may include determining which of a plurality of first candidate rotation matrixes yields a smallest sum of a norm of a product of one of the plurality of first candidate rotation matrixes and one of the plurality of sets of accelerometer measurement values, minus a gravity vector in the reference coordinate system, for each of the first portion of the plurality of sets of accelerometer measurement values. For example, the apparatus 705 and/or the UE 500 may determine the first rotation matrix in accordance with Equation (3) using at least some of the available acceleration measurements with the UE 500 at rest.

Also or alternatively, implementations of the method 1000 may include one or more of the following features. In an example implementation, determining the sensor calibration parameters may include: determining a plurality of intermediate sensor values by applying the first rotational matrix to the second portion of the plurality of sets of sensor measurement values; and determining a second rotation matrix, based on the plurality of intermediate sensor values and expected values of the plurality of intermediate sensor values, to rotate the sensor coordinate system to align the second sensor axis with the second reference axis and to align the third sensor axis with the third reference axis. For example, Equations (4)-(7) may be used to determine the second rotation matrix R(θ) as discussed above with respect to stage 740 or stage 940. The processor 510, possibly in combination with the memory 530, and the sensor(s) 540 may comprise means for determining a plurality of intermediate sensor values. Also or alternatively the processor 410, possibly in combination with the memory 411, and the transceiver 415 (e.g., the wireless receiver 444 and the antenna 446) may comprise means for determining a plurality of intermediate sensor values. Also or alternatively the processor 310, possibly in combination with the memory 311, and the transceiver 315 (e.g., the wireless receiver 344 and the antenna 346) may comprise means for determining a plurality of intermediate sensor values. The processor 510, possibly in combination with the memory 530, and/or the processor 410 (possibly in combination with the memory 411), and/or the processor 310 (possibly in combination with the memory 311) may comprise means for determining a second rotation matrix. In another example implementation, determining the second rotation matrix may include determining which of a plurality of second candidate rotation matrixes yields a smallest sum of a norm of a product of one of the plurality of second candidate rotation matrixes and one of the plurality of intermediate sensor values, minus a corresponding one of the expected values of the plurality of intermediate sensor values, for each of the plurality of intermediate sensor values. For example, the apparatus 705 and/or the UE 500 may calculate the rotation matrix R(θ*) using Equation (4). The second portion of the sensor measurement values may be different from the first portion of the sensor measurement values (e.g., the second portion of the sensor measurement values may be measured while the UE 500 is in motion, although the second portion may also include measurements while the UE 500 is at rest). The processor 510, possibly in combination with the memory 530, and/or the processor 410 (possibly in combination with the memory 441), and/or the processor 310 (possibly in combination with the memory 311) may comprise means for determining which of the plurality of second candidate rotation matrixes yields the smallest sum. In another example implementation, the plurality of sets of sensor measurement values may be a plurality of sets of accelerometer measurement values and the expected values of the plurality of intermediate sensor values may be expected acceleration values. For example, the expected acceleration values may be determined based on determined or known position of the UE 500 over time.

Also or alternatively, implementations of the method 1000 may include one or more of the following features. In an example implementation, the method 1000 includes obtaining a plurality of locations of the user equipment, and determining the sensor calibration parameters comprises determining the sensor calibration parameters based on the plurality of locations of the user equipment. For example, the calibration apparatus 705 or the UE 500 may obtain locations of the UE 500 via the positioning information 735, 737 or the positioning information 935, 936, respectively. The calibration apparatus 705 or the UE 500 may determine the sensor calibration parameters using multiple positions of the UE 500 as discussed above with respect to stage 740 or stage 940, respectively. The processor 510, possibly in combination with the memory 530, in combination with the transceiver (e.g., the wireless receiver 244 and the antenna 246) and/or the processor 410 (possibly in combination with the memory 441 and the transceiver 415 (e.g., the wired receiver 454 and/or the wireless receiver 444 and the antenna 446)), and/or the processor 310 (possibly in combination with the memory 311 and the transceiver 315 (e.g., the wired receiver 354 and/or the wireless receiver 344 and the antenna 346)) may comprise means for obtaining the plurality of locations of the user equipment. The processor 510, possibly in combination with the memory 530, and/or the processor 410 (possibly in combination with the memory 441) and/or the processor 310 (possibly in combination with the memory 311) may comprise means for determining the sensor calibration parameters. In another example implementation, either obtaining the plurality of locations of the user equipment comprises receiving the plurality of locations of the user equipment at the user equipment from a first network entity, or obtaining the plurality of locations of the user equipment comprises obtaining the plurality of locations of the user equipment at a second network entity based on positioning information received at the second network entity from one or more of the user equipment or one or more base stations. For example, the UE 500 may receive the locations of the UE 500 in the positioning information 935 and/or the positioning information 936. As another example, the calibration apparatus 705 may receive the locations in the positioning information 735 and/or the positioning information 737, and/or determine the locations based on information (e.g., measurements) in the positioning information 735 and/or the positioning information 737. The processor 510, possibly in combination with the memory 530, in combination with the transceiver (e.g., the wireless receiver 244 and the antenna 246) and/or the processor 410 (possibly in combination with the memory 441 and the transceiver 415 (e.g., the wired receiver 454 and/or the wireless receiver 444 and the antenna 446)), and/or the processor 310 (possibly in combination with the memory 311 and the transceiver 315 (e.g., the wired receiver 354 and/or the wireless receiver 344 and the antenna 346)) may comprise means for obtaining the plurality of locations of the user equipment.

### IMPLEMENTATION EXAMPLES

Implementation examples are provided in the following numbered clauses.

1. An apparatus for determining sensor calibration parameters, the apparatus comprising:

a memory;

at least one of a first sensor or a transceiver; and

a processor communicatively coupled to the memory and to the at least one of the first sensor or the transceiver, wherein the processor is configured to:

obtain, via the at least one of the first sensor or the transceiver, a plurality of sets of sensor measurement values, in a sensor coordinate system, of a second sensor of a user equipment; and

determine the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

2. The apparatus of clause 1, wherein the reference coordinate system includes a first reference axis, a second reference axis, and a third reference axis, and the sensor coordinate system includes a first sensor axis, a second sensor axis, and a third sensor axis, and wherein, to determine the sensor calibration parameters, the processor is configured to determine a first rotation matrix, based on the first portion of the plurality of sets of sensor measurement values and a reference value of the first reference axis, to rotate the sensor coordinate system to align the first sensor axis with the first reference axis.

3. The apparatus of clause 2, wherein the plurality of sets of sensor measurement values is a plurality of sets of accelerometer measurement values.

4. The apparatus of clause 3, wherein the reference value is a reference acceleration value, and the first reference axis is aligned with a direction of gravity and the reference acceleration value is a gravitational acceleration.

5. The apparatus of clause 3, wherein, to determine the first rotation matrix, the processor is configured to determine which of a plurality of first candidate rotation matrixes yields a smallest sum of a norm of a product of one of the plurality of first candidate rotation matrixes and one of the plurality of sets of accelerometer measurement values, minus a gravity vector in the reference coordinate system, for each of the first portion of the plurality of sets of accelerometer measurement values.

6. The apparatus of clause 2, wherein to determine the sensor calibration parameters, the processor is configured to:

determine a plurality of intermediate sensor values by applying the first rotation matrix to the second portion of the plurality of sets of sensor measurement values; and

determine a second rotation matrix, based on the plurality of intermediate sensor values and expected values of the plurality of intermediate sensor values, to rotate the sensor coordinate system to align the second sensor axis with the second reference axis and to align the third sensor axis with the third reference axis.

7. The apparatus of clause 6, wherein, to determine the second rotation matrix, the processor is configured to determine which of a plurality of second candidate rotation matrixes yields a smallest sum of a norm of a product of one of the plurality of second candidate rotation matrixes and one of the plurality of intermediate sensor values, minus a corresponding one of the expected values of the plurality of intermediate sensor values, for each of the plurality of intermediate sensor values.

8. The apparatus of clause 7, wherein the plurality of sets of sensor measurement values is a plurality of sets of accelerometer measurement values and the expected values of the plurality of intermediate sensor values are expected acceleration values.

9. The apparatus of clause 1, wherein the apparatus comprises the transceiver, and the processor is further configured to obtain a plurality of locations of the user equipment and to determine the sensor calibration parameters based on the plurality of locations of the user equipment.

10. The apparatus of clause 9, wherein either:

the apparatus is the user equipment and the processor is configured to obtain the plurality of locations of the user equipment from a first network entity via the transceiver; or

the apparatus is a second network entity, the processor is configured to obtain, via the transceiver, the plurality of sets of sensor measurement values and to obtain the plurality of locations of the user equipment based on positioning information received via the transceiver from one or more of the user equipment or one or more base stations.

11. An apparatus for determining sensor calibration parameters, the apparatus comprising:

means for obtaining a plurality of sets of sensor measurement values, in a sensor coordinate system, of a sensor of a user equipment; and

means for determining the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

12. The apparatus of clause 11, wherein the reference coordinate system includes a first reference axis, a second reference axis, and a third reference axis, and the sensor coordinate system includes a first sensor axis, a second sensor axis, and a third sensor axis, and wherein the means for determining the sensor calibration parameters include means for determining a first rotation matrix, based on the first portion of the plurality of sets of sensor measurement values and a reference value of the first reference axis, to rotate the sensor coordinate system to align the first sensor axis with the first reference axis.

13. The apparatus of clause 12, wherein the plurality of sets of sensor measurement values is a plurality of sets of accelerometer measurement values.

14. The apparatus of clause 13, wherein the reference value is a reference acceleration value, and the first reference axis is aligned with a direction of gravity and the reference acceleration value is a gravitational acceleration.

15. The apparatus of clause 13, wherein the means for determining the first rotation matrix include means for determining which of a plurality of first candidate rotation matrixes yields a smallest sum of a norm of a product of one of the plurality of first candidate rotation matrixes and one of the plurality of sets of accelerometer measurement values, minus a gravity vector in the reference coordinate system, for each of the first portion of the plurality of sets of accelerometer measurement values.

16. The apparatus of clause 12, wherein the means for determining the sensor calibration parameters include:

means for determining a plurality of intermediate sensor values by applying the first rotation matrix to the second portion of the plurality of sets of sensor measurement values; and

means for determining a second rotation matrix, based on the plurality of intermediate sensor values and expected values of the plurality of intermediate sensor values, to rotate the sensor coordinate system to align the second sensor axis with the second reference axis and to align the third sensor axis with the third reference axis.

17. The apparatus of clause 16, wherein the means for determining the second rotation matrix include means for determining which of a plurality of second candidate rotation matrixes yields a smallest sum of a norm of a product of one of the plurality of second candidate rotation matrixes and one of the plurality of intermediate sensor values, minus a corresponding one of the expected values of the plurality of intermediate sensor values, for each of the plurality of intermediate sensor values.

18. The apparatus of clause 17, wherein the plurality of sets of sensor measurement values is a plurality of sets of accelerometer measurement values and the expected values of the plurality of intermediate sensor values are expected acceleration values.

19. The apparatus of clause 11, further comprising means for obtaining a plurality of locations of the user equipment, and wherein the means for determining the sensor calibration parameters comprise means for determining the sensor calibration parameters based on the plurality of locations of the user equipment.

20. The apparatus of clause 19, wherein either:

the apparatus is the user equipment and the means for obtaining the plurality of locations of the user equipment comprise means for receiving the plurality of locations of the user equipment from a first network entity; or

the apparatus is a second network entity, and the means for obtaining the plurality of locations of the user equipment comprise means for obtaining the plurality of locations of the user equipment based on positioning information received from one or more of the user equipment or one or more base stations.

21. A method for determining sensor calibration parameters, the method comprising:

obtaining a plurality of sets of sensor measurement values, in a sensor coordinate system, of a sensor of a user equipment; and

determining the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

22. The method of clause 21, wherein the reference coordinate system includes a first reference axis, a second reference axis, and a third reference axis, and the sensor coordinate system includes a first sensor axis, a second sensor axis, and a third sensor axis, and wherein determining the sensor calibration parameters includes determining a first rotation matrix, based on the first portion of the plurality of sets of sensor measurement values and a reference value of the first reference axis, to rotate the sensor coordinate system to align the first sensor axis with the first reference axis.

23. The method of clause 22, wherein the plurality of sets of sensor measurement values is a plurality of sets of accelerometer measurement values.

24. The method of clause 23, wherein the reference value is a reference acceleration value, and the first reference axis is aligned with a direction of gravity and the reference acceleration value is a gravitational acceleration.

25. The method of clause 23, wherein determining the first rotation matrix includes determining which of a plurality of first candidate rotation matrixes yields a smallest sum of a norm of a product of one of the plurality of first candidate rotation matrixes and one of the plurality of sets of accelerometer measurement values, minus a gravity vector in the reference coordinate system, for each of the first portion of the plurality of sets of accelerometer measurement values.

26. The method of clause 22, wherein determining the sensor calibration parameters includes:

determining a plurality of intermediate sensor values by applying the first rotation matrix to the second portion of the plurality of sets of sensor measurement values; and

determining a second rotation matrix, based on the plurality of intermediate sensor values and expected values of the plurality of intermediate sensor values, to rotate the sensor coordinate system to align the second sensor axis with the second reference axis and to align the third sensor axis with the third reference axis.

27. The method of clause 26, wherein determining the second rotation matrix includes determining which of a plurality of second candidate rotation matrixes yields a smallest sum of a norm of a product of one of the plurality of second candidate rotation matrixes and one of the plurality of intermediate sensor values, minus a corresponding one of the expected values of the plurality of intermediate sensor values, for each of the plurality of intermediate sensor values.

28. The method of clause 27, wherein the plurality of sets of sensor measurement values is a plurality of sets of accelerometer measurement values and the expected values of the plurality of intermediate sensor values are expected acceleration values.

29. The method of clause 21, further comprising obtaining a plurality of locations of the user equipment, and wherein determining the sensor calibration parameters comprises determining the sensor calibration parameters based on the plurality of locations of the user equipment.

30. The method of clause 29, wherein either:

obtaining the plurality of locations of the user equipment comprises receiving the plurality of locations of the user equipment at the user equipment from a first network entity; or

obtaining the plurality of locations of the user equipment comprises obtaining the plurality of locations of the user equipment at a second network entity based on positioning information received at the second network entity from one or more of the user equipment or one or more base stations.

31. A non-transitory, processor-readable storage medium comprising instructions configured to cause a processor, in order to determine sensor calibration parameters, to:

obtain a plurality of sets of sensor measurement values, in a sensor coordinate system, of a sensor of a user equipment; and

determine the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

32. The storage medium of clause 31, wherein the reference coordinate system includes a first reference axis, a second reference axis, and a third reference axis, and the sensor coordinate system includes a first sensor axis, a second sensor axis, and a third sensor axis, and wherein the processor-readable instructions configured to cause the processor to determine the sensor calibration parameters include processor-readable instructions configured to cause the processor to determine a first rotation matrix, based on the first portion of the plurality of sets of sensor measurement values and a reference value of the first reference axis, to rotate the sensor coordinate system to align the first sensor axis with the first reference axis.

33. The storage medium of clause 32, wherein the plurality of sets of sensor measurement values is a plurality of sets of accelerometer measurement values.

34. The storage medium of clause 33, wherein the reference value is a reference acceleration value, and the first reference axis is aligned with a direction of gravity and the reference acceleration value is a gravitational acceleration.

35. The storage medium of clause 33, wherein the processor-readable instructions configured to cause the processor to determine the first rotation matrix include processor-readable instructions configured to cause the processor to determine which of a plurality of first candidate rotation matrixes yields a smallest sum of a norm of a product of one of the plurality of first candidate rotation matrixes and one of the plurality of sets of accelerometer measurement values, minus a gravity vector in the reference coordinate system, for each of the first portion of the plurality of sets of accelerometer measurement values.

36. The storage medium of clause 32, wherein the processor-readable instructions configured to cause the processor to determine the sensor calibration parameters include processor-readable instructions configured to cause the processor to:

determine a plurality of intermediate sensor values by applying the first rotation matrix to the second portion of the plurality of sets of sensor measurement values; and

determine a second rotation matrix, based on the plurality of intermediate sensor values and expected values of the plurality of intermediate sensor values, to rotate the sensor coordinate system to align the second sensor axis with the second reference axis and to align the third sensor axis with the third reference axis.

37. The storage medium of clause 36, wherein the processor-readable instructions configured to cause the processor to determine the second rotation matrix include processor-readable instructions configured to cause the processor to determine which of a plurality of second candidate rotation matrixes yields a smallest sum of a norm of a product of one of the plurality of second candidate rotation matrixes and one of the plurality of intermediate sensor values, minus a corresponding one of the expected values of the plurality of intermediate sensor values, for each of the plurality of intermediate sensor values.

38. The storage medium of clause 37, wherein the plurality of sets of sensor measurement values is a plurality of sets of accelerometer measurement values and the expected values of the plurality of intermediate sensor values are expected acceleration values.

39. The storage medium of clause 31, further comprising processor-readable instructions to cause the processor to obtain a plurality of locations of the user equipment, and wherein the processor-readable instructions to cause the processor to determine the sensor calibration parameters comprise processor-readable instructions to cause the processor to determine the sensor calibration parameters based on the plurality of locations of the user equipment.

40. The storage medium of clause 39, wherein either:

the processor is a processor of the user equipment and the processor-readable instructions to cause the processor to obtain the plurality of locations of the user equipment comprise processor-readable instructions to cause the processor to receive the plurality of locations of the user equipment from a first network entity; or

the processor is a processor of a second network entity, and the processor-readable instructions to cause the processor to obtain the plurality of locations of the user equipment comprise processor-readable instructions to cause the processor to obtain the plurality of locations of the user equipment based on positioning information received from one or more of the user equipment or one or more base stations.

### OTHER CONSIDERATIONS

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Components, functional or otherwise, shown in the figures and/or discussed herein as being connected or communicating with each other are communicatively coupled unless otherwise noted. That is, they may be directly or indirectly connected to enable communication between them.

As used herein, unless otherwise stated, a statement that a function or operation is “based on” an item or condition means that the function or operation is based on the stated item or condition and may be based on one or more items and/or conditions in addition to the stated item or condition.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An apparatus for determining sensor calibration parameters, the apparatus comprising:
a memory;
at least one of a first sensor or a transceiver; and
a processor communicatively coupled to the memory and to the at least one of the first sensor or the transceiver, wherein the processor is configured to:
obtain, via the at least one of the first sensor or the transceiver, a plurality of sets of sensor measurement values, in a sensor coordinate system, of a second sensor of a user equipment; and
determine the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

2. The apparatus of claim 1, wherein the reference coordinate system includes a first reference axis, a second reference axis, and a third reference axis, and the sensor coordinate system includes a first sensor axis, a second sensor axis, and a third sensor axis, and wherein, to determine the sensor calibration parameters, the processor is configured to determine a first rotation matrix, based on the first portion of the plurality of sets of sensor measurement values and a reference value of the first reference axis, to rotate the sensor coordinate system to align the first sensor axis with the first reference axis.

3. The apparatus of claim 2, wherein the plurality of sets of sensor measurement values is a plurality of sets of accelerometer measurement values.

4. The apparatus of claim 3, wherein the reference value is a reference acceleration value, and the first reference axis is aligned with a direction of gravity and the reference acceleration value is a gravitational acceleration.

5. The apparatus of claim 3, wherein, to determine the first rotation matrix, the processor is configured to determine which of a plurality of first candidate rotation matrixes yields a smallest sum of a norm of a product of one of the plurality of first candidate rotation matrixes and one of the plurality of sets of accelerometer measurement values, minus a gravity vector in the reference coordinate system, for each of the first portion of the plurality of sets of accelerometer measurement values.

6. The apparatus of claim 2, wherein to determine the sensor calibration parameters, the processor is configured to:
determine a plurality of intermediate sensor values by applying the first rotation matrix to the second portion of the plurality of sets of sensor measurement values; and
determine a second rotation matrix, based on the plurality of intermediate sensor values and expected values of the plurality of intermediate sensor values, to rotate the sensor coordinate system to align the second sensor axis with the second reference axis and to align the third sensor axis with the third reference axis.

7. The apparatus of claim 6, wherein, to determine the second rotation matrix, the processor is configured to determine which of a plurality of second candidate rotation matrixes yields a smallest sum of a norm of a product of one of the plurality of second candidate rotation matrixes and one of the plurality of intermediate sensor values, minus a corresponding one of the expected values of the plurality of intermediate sensor values, for each of the plurality of intermediate sensor values.

8. The apparatus of claim 7, wherein the plurality of sets of sensor measurement values is a plurality of sets of accelerometer measurement values and the expected values of the plurality of intermediate sensor values are expected acceleration values.

9. The apparatus of claim 1, wherein the apparatus comprises the transceiver, and the processor is further configured to obtain a plurality of locations of the user equipment and to determine the sensor calibration parameters based on the plurality of locations of the user equipment.

10. The apparatus of claim 9, wherein either:
the apparatus is the user equipment and the processor is configured to obtain the plurality of locations of the user equipment from a first network entity via the transceiver; or
the apparatus is a second network entity, the processor is configured to obtain, via the transceiver, the plurality of sets of sensor measurement values and to obtain the plurality of locations of the user equipment based on positioning information received via the transceiver from one or more of the user equipment or one or more base stations.

11. An apparatus for determining sensor calibration parameters, the apparatus comprising:
means for obtaining a plurality of sets of sensor measurement values, in a sensor coordinate system, of a sensor of a user equipment; and
means for determining the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

12. The apparatus of claim 11, wherein the reference coordinate system includes a first reference axis, a second reference axis, and a third reference axis, and the sensor coordinate system includes a first sensor axis, a second sensor axis, and a third sensor axis, and wherein the means for determining the sensor calibration parameters include means for determining a first rotation matrix, based on the first portion of the plurality of sets of sensor measurement values and a reference value of the first reference axis, to rotate the sensor coordinate system to align the first sensor axis with the first reference axis.

13. The apparatus of claim 12, wherein the plurality of sets of sensor measurement values is a plurality of sets of accelerometer measurement values.

14. The apparatus of claim 13, wherein the reference value is a reference acceleration value, and the first reference axis is aligned with a direction of gravity and the reference acceleration value is a gravitational acceleration.

15. The apparatus of claim 13, wherein the means for determining the first rotation matrix include means for determining which of a plurality of first candidate rotation matrixes yields a smallest sum of a norm of a product of one of the plurality of first candidate rotation matrixes and one of the plurality of sets of accelerometer measurement values, minus a gravity vector in the reference coordinate system, for each of the first portion of the plurality of sets of accelerometer measurement values.

16. The apparatus of claim 12, wherein the means for determining the sensor calibration parameters include:
means for determining a plurality of intermediate sensor values by applying the first rotation matrix to the second portion of the plurality of sets of sensor measurement values; and
means for determining a second rotation matrix, based on the plurality of intermediate sensor values and expected values of the plurality of intermediate sensor values, to rotate the sensor coordinate system to align the second sensor axis with the second reference axis and to align the third sensor axis with the third reference axis.

17. The apparatus of claim 16, wherein the means for determining the second rotation matrix include means for determining which of a plurality of second candidate rotation matrixes yields a smallest sum of a norm of a product of one of the plurality of second candidate rotation matrixes and one of the plurality of intermediate sensor values, minus a corresponding one of the expected values of the plurality of intermediate sensor values, for each of the plurality of intermediate sensor values.

18. The apparatus of claim 17, wherein the plurality of sets of sensor measurement values is a plurality of sets of accelerometer measurement values and the expected values of the plurality of intermediate sensor values are expected acceleration values.

19. A method for determining sensor calibration parameters, the method comprising:
obtaining a plurality of sets of sensor measurement values, in a sensor coordinate system, of a sensor of a user equipment; and
determining the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.

20. The method of claim 19, wherein the reference coordinate system includes a first reference axis, a second reference axis, and a third reference axis, and the sensor coordinate system includes a first sensor axis, a second sensor axis, and a third sensor axis, and wherein determining the sensor calibration parameters includes determining a first rotation matrix, based on the first portion of the plurality of sets of sensor measurement values and a reference value of the first reference axis, to rotate the sensor coordinate system to align the first sensor axis with the first reference axis.

21. The method of claim 20, wherein the plurality of sets of sensor measurement values is a plurality of sets of accelerometer measurement values.

22. The method of claim 21, wherein the reference value is a reference acceleration value, and the first reference axis is aligned with a direction of gravity and the reference acceleration value is a gravitational acceleration.

23. The method of claim 21, wherein determining the first rotation matrix includes determining which of a plurality of first candidate rotation matrixes yields a smallest sum of a norm of a product of one of the plurality of first candidate rotation matrixes and one of the plurality of sets of accelerometer measurement values, minus a gravity vector in the reference coordinate system, for each of the first portion of the plurality of sets of accelerometer measurement values.

24. The method of claim 20, wherein determining the sensor calibration parameters includes:
determining a plurality of intermediate sensor values by applying the first rotation matrix to the second portion of the plurality of sets of sensor measurement values; and
determining a second rotation matrix, based on the plurality of intermediate sensor values and expected values of the plurality of intermediate sensor values, to rotate the sensor coordinate system to align the second sensor axis with the second reference axis and to align the third sensor axis with the third reference axis.

25. The method of claim 24, wherein determining the second rotation matrix includes determining which of a plurality of second candidate rotation matrixes yields a smallest sum of a norm of a product of one of the plurality of second candidate rotation matrixes and one of the plurality of intermediate sensor values, minus a corresponding one of the expected values of the plurality of intermediate sensor values, for each of the plurality of intermediate sensor values.

26. The method of claim 25, wherein the plurality of sets of sensor measurement values is a plurality of sets of accelerometer measurement values and the expected values of the plurality of intermediate sensor values are expected acceleration values.

27. The method of claim 19, further comprising obtaining a plurality of locations of the user equipment, and wherein determining the sensor calibration parameters comprises determining the sensor calibration parameters based on the plurality of locations of the user equipment.

28. The method of claim 27, wherein either:
obtaining the plurality of locations of the user equipment comprises receiving the plurality of locations of the user equipment at the user equipment from a first network entity; or
obtaining the plurality of locations of the user equipment comprises obtaining the plurality of locations of the user equipment at a second network entity based on positioning information received at the second network entity from one or more of the user equipment or one or more base stations.

29. A non-transitory, processor-readable storage medium comprising instructions configured to cause a processor, in order to determine sensor calibration parameters, to:
obtain a plurality of sets of sensor measurement values, in a sensor coordinate system, of a sensor of a user equipment; and
determine the sensor calibration parameters, based on a first portion of the plurality of sets of sensor measurement values corresponding to first times at which the user equipment is at rest and based on a second portion of the plurality of sets of sensor measurement values at least some of which correspond to second times at which the user equipment is in motion, such that application of the sensor calibration parameters to a selected set of the plurality of sets of sensor measurement values yields a calibrated set of calibrated sensor measurement values in a reference coordinate system.
